(19) United States
(12) Patent Application Publication
(10) Pub. No.: US 2007/0021965 A1
(43) Pub. Date: Jan. 25, 2007

(54) System and method for selecting a pillow

(76) Inventor: Dennis M. Boyd, Maryland Heights, MO (US)

Correspondence Address: THOMPSON COBURN, LLP, ONE US BANK PLAZA, SUITE 3500, ST LOUIS, MO, 63101, US

(21) Appl. No.: 11/184,427

(22) Filed: Jul. 19, 2005

(51) Int. Cl. G06Q 99/00; G06Q 30/00

(52) U.S. Cl. 705/1

(57) ABSTRACT

A system and method of selecting a pillow is disclosed. The system includes a pillow selection device adapted to display a plurality of pillow selection criteria from which an individual can determine at least one recommended pillow model based on the individual's personal pillow selection criteria. In one embodiment, the pillow selection device is in the form of at least one card having a grid with a plurality of rows and columns which define a plurality of slots, each slot representing a set of pillow selection criteria and identifying at least one pillow model recommended for that set of pillow selection criteria. In another embodiment, the pillow selection device is implemented in software which provides a graphical user interface configured to request and receive input from the individual related to his or her pillow selection criteria and which determined at least one recommended pillow based on the inputted pillow selection criteria. Methods of selecting a pillow in accordance with the above-described system are also disclosed.

### FIELD OF THE INVENTION

This invention relates to a system and method for selecting a pillow.

### BACKGROUND OF THE INVENTION

Most everyone desires a good night's rest. Choosing the right pillow for a person's mattress and sleep characteristics is essential to ensuring a restful sleep. The correct pillow enhances a person's sleep by adding to the comfort of the mattress. The correct pillow also ensures proper spinal alignment. Selecting the wrong pillow can result in an improper neck, shoulder, and spinal alignment which can result in poor sleep efficiency and/or pain.

However, choosing the correct pillow for a person's mattress and sleep characteristics can be difficult. There are many different types of pillows available on the market today. Some vary in content (i.e., foam, fiber, air, or water), and some vary in shape (i.e., contour, flat, bulky, wide, or narrow). Pillows also vary in height and width, and in compression or interload force deflection (“IFD”). Soft pillows have a relatively low IFD while firm pillows have a relatively high IFD. The number of choices of pillows increases the probability that a person will select the wrong pillow for his or her mattress and sleep characteristics.

The number of different types of mattresses available on the market compounds the problem. For instance, certain types of pillows complement foam mattresses, while others work best with waterbeds. Some types of pillows work better with innerspring mattresses, and yet others work better with air beds. While each of these types of mattresses may be generally categorized as a plush or soft, medium, or firm, the relative firmness of a pillow must complement the relative firmness of the mattress. Although compression tests may also be used to objectively measure the firmness of these types of mattresses, many people do not correctly categorize the relative firmness of their mattress.

Another major variable affecting pillow selection is a person's sleeping position. A person may prefer to sleep on their side, back, stomach or may alternate between these positions. Some research has shown that 68% of the U.S. population sleeps on their side, 16% on their back, 8% on their stomach and 8% use multiple positions. Moreover, the position that a person prefers in order to fall asleep may be different than the person's predominant position while sleeping.

With all of these variables, it is often difficult for a consumer to determine the proper pillow for their individual use. Most pillows are purchased from mass merchants where there is no consultive selling. Consequently, many consumers chose the wrong pillow for their type use. Even in a situation where the consumer is purchasing from a store that has professional sales assistance (i.e., mattress stores, furniture stores, and department stores), time and training constraints make it difficult for these salespeople to sufficiently probe the consumer as to his or her mattress and sleep characteristics, and process this information correctly so as to determine the appropriate pillow for the consumer. It is clear that an effective tool to assist consumers is the selection of a proper pillow is needed.

### SUMMARY OF THE INVENTION

The present invention provides a method and apparatus for assisting an individual in the selection of a pillow. In one aspect of the present invention, the system comprises a pillow selection device adapted to display pillow selection criteria from which the individual can determine at least one recommended pillow model based on the individual's pillow selection criteria. The pillow selection criteria include at least one of a mattress type, sleeping position, gender, height, propensity to snore, the presence or absence of allergies, the presence or absence of shoulder pain, and the presence or absence of neck pain. The pillow selection device may be in the form of at least one pillow selection card, the pillow selection card comprising a plurality of rows and columns defining a plurality of slots, each slot representing a set of pillow selection criteria and identifying at least one pillow model recommended for that set of pillow selection criteria. The pillow selection device may comprise a plurality of such pillow selection cards, each pillow selection card corresponding to a range of heights.

In another aspect of the invention, a computer-readable medium having computer-executable instructions for performing steps in a computer system for assisting an individual having certain pillow selection criteria in the selection of a pillow is disclosed. The steps include providing a graphical user interface configured to request and receive input from the individual related to his or her pillow selection criteria, and determining at least one recommended pillow for the individual based on the received pillow selection criteria, and may further include determining at least one recommended mattress pad and topper for the recommended pillow. The step of determining involves identifying a pillow model for each of the plurality of pillows, correlating each pillow model to a set of pillow selection criteria. The pillow selection criteria include at least one of a mattress type, sleeping position, gender, height, propensity to snore, the presence or absence of shoulder pain, and the presence or absence of neck pain. The steps may further comprise storing the individual's pillow selection criteria. The graphical user interface is preferably configured to display graphics indicative of the input received, such as a sleeping position and/or the individual's gender.

In another aspect of the invention, a system for assisting an individual in the selection of a pillow from a plurality of pillows is disclosed. The system comprises a graphical user interface configured to request and receive input from the individual related to his or her pillow selection criteria, and means for determining at least one recommended pillow for the individual based on the received pillow selection criteria. The system may further include means for determining at least one recommended mattress pad and topper for the recommended pillow. The determining means comprises identifying a pillow model for each of the plurality of pillows, and correlating each pillow model to a set of pillow selection criteria. Again, the pillow selection criteria include at least one of a mattress type, sleeping position, gender, height, propensity to snore, the presence or absence of shoulder pain, and the presence or absence of neck pain. In one embodiment, the graphical user interface comprises a touch screen, and in another embodiment it comprises a display and at least one of a keyboard and a mouse. The system may further comprise means for storing the individual's pillow selection criteria. In a preferred embodiment, the graphical user interface is configured to display graphics indicative of the input received, such as a sleeping position and/or the individual's gender. In a preferred embodiment, each of the plurality of pillows comprises packaging having its corresponding pillow model identified thereon.

In another aspect of the invention, a method of assisting an individual in the selection of a pillow from a plurality of pillows based on his or her pillow selection criteria is disclosed. The method comprises presenting a plurality of screen displays to the individual requesting his or her pillow selection criteria, receiving the individual's pillow selection criteria, and determining at least one recommended pillow based on the received pillow selection criteria, and may also comprise determining at least one recommended mattress pad and topper for the recommended pillow. The step of determining comprises identifying a pillow model for each of the plurality of pillows, and correlating each pillow model to a set of pillow selection criteria.

Further objects and features of the invention are revealed in the following detailed description of the preferred embodiment of the invention and in the drawings which follow.

### BRIEF DESCRIPTION OF THE DRAWINGS

FIG. 1 shows implementation of a pillow selection system in accordance with one embodiment of the present invention employed in a retail store environment;

FIGS. 2-4 show one embodiment of the pillow selector device of FIG. 1;

FIG. 5 shows a pillow selection system in accordance with another embodiment of the present invention;

FIG. 6 shows the display of FIG. 5 with information related to a prospective pillow purchaser's sleep position pillow selection criteria displayed thereon;

FIG. 7 shows the display of FIG. 5 with information related to a pillow recommended by the pillow selection device of FIG. 5; and

FIG. 8 shows the display of FIG. 5 with information related to a plurality of available brands and corresponding price of the recommended pillow of FIG. 7.

Corresponding reference numbers indicate corresponding parts throughout the several views of the drawings.

### DETAILED DESCRIPTION OF THE PREFERRED EMBODIMENT

The inventors have conducted, reviewed and analyzed extensive research and studies to assist in determining the proper head, neck, and spinal alignment for various pillow types for various sleeping positions based upon various firmness levels of mattresses, as well as other relevant pillow selection criteria as discussed herein. This information was then interpreted, correlated and extrapolated to popular pillow products available on the market and most likely to be stocked by a retail, catalog or online establishment. A database containing all of this information was then created. Based on the database information, it was then determined which pillow or pillows subjectively give a user having certain pillow selection criteria the most comfort.

Two pillow selection criteria found to be the most critical in the pillow selection process are: (1) the type of mattress, that is, whether the mattress is firm, medium or soft; and (2) the preferred sleeping position, that is, side, back, stomach, or a combination thereof. For instance, persons sleeping on their sides were found to generally have a greater need for a pillow with a high loft and/or a higher IFD to keep their head in alignment with their neck and spine while lying on the pillow. A side sleeper on a plush mattress was found to not need as tall of a pillow as a side sleeper on a firm mattress since the shoulder of the side sleeper was found to dip into the mattress deeper on a plush mattress than a firm mattress, thus reducing the distance between the person's head and the mattress. Persons sleeping on their backs were generally found to be more comfortable with contour pillows as the contoured pillow provided support to the neck and opened up their air passages to breathe more freely. Other pillow selection criteria identified as relevant to the pillow selection process include, without limitation, a person's gender, height, propensity to snore, and the presence or absence of allergies, shoulder pain, and neck pain.

As will become evident from the discussion that follows, the content of the database may vary. Such variations may occur for several reasons, including without limitation changes in the pillow products available on the market, and additions or deletions of pillow selection criteria that are identified as relevant to the pillow selection process. The database may also vary in the way that certain pillow products are correlated to a desired or recommended pillow characteristic.

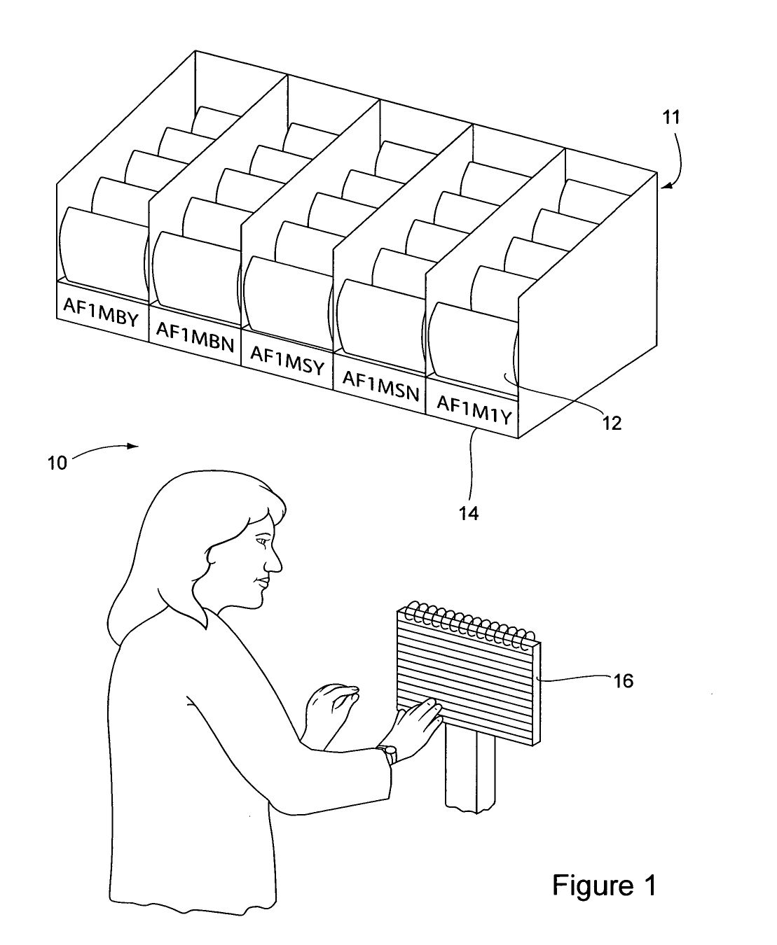

FIG. 1 shows an implementation of a pillow selection system 10 in accordance with one embodiment of the present invention employed in a retail store environment. The pillow selection system 10 comprises a pillow display 11 and a pillow selection device 16. The pillow display 11 has a plurality of pillows 12 displayed in close proximity to their corresponding pillow models 14. The pillow selection device 16 is in turn preferably placed in close proximity to the pillow display 11 and is preferably configured to be user friendly and intuitive so a purchaser may easily assist themselves in selecting a proper pillow. Once a purchaser determines the recommended pillow for his or her pillow selection criteria from the pillow selection device 16, the purchaser can then proceed to purchase the recommended pillow. In a preferred embodiment, the pillow selection system also includes a request form (not shown) from which the purchaser can write down the recommended pillow model. He or she can then simply give the form to a salesperson who can then retrieve the pillow. Such a configuration is especially helpful where space constraints prevent a store from displaying some or all of its pillows. In addition, the pillow selection device 16 may be incorporated into a larger display that includes advertising and other promotional material.

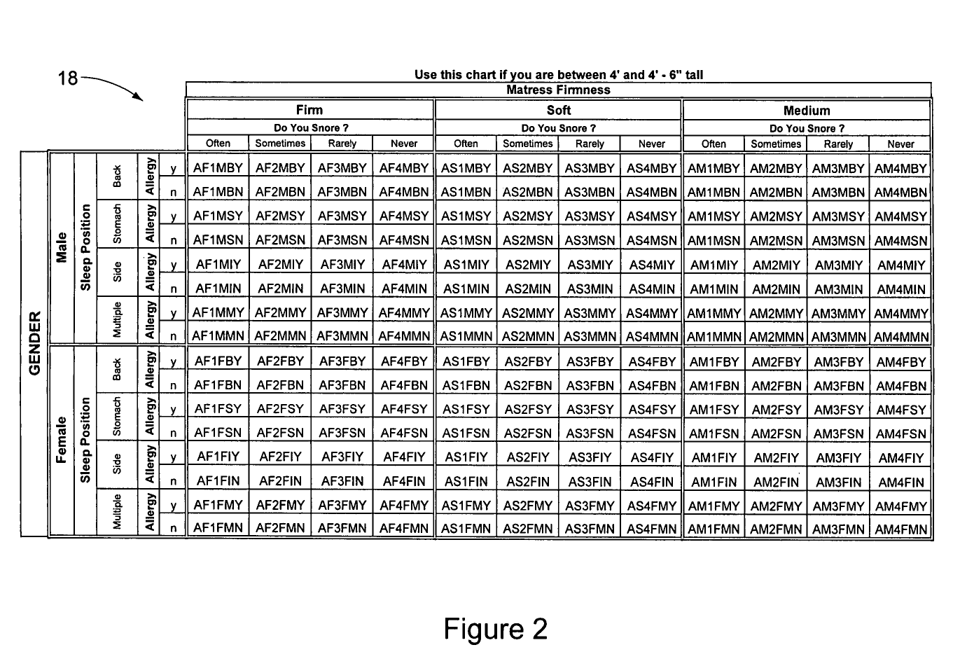

FIGS. 2-4 show one embodiment of the pillow selection device 16 of FIG. 1. The pillow selection device 16 comprises a pillow selection card 18 having a plurality of rows and columns defining a plurality of slots, each slot representing a set of pillow selection criteria and identifying a pillow model recommended for that set of pillow selection criteria. In a preferred embodiment, each slot may also identify a recommended mattress pad and/or topper for that set of pillow selection criteria. Alternatively, system 10 may include a separate mattress pad and/or topper selection device (not shown) similar to pillow selection device 16 which identifies at least one recommended mattress pad and/or topper for each pillow model identified by pillow selection device 16. In the embodiment shown in FIGS. 2-4, the pillow selection device 16 is in the form of a booklet having several cards 18-20 with each card corresponding to a range of heights. For instance, FIG. 2 shows a card 18 appropriate for a purchaser having a height of between 4 feet and 4 foot and 6 inches. If a purchaser has a different height, the purchaser would flip the booklet to the appropriate page (e.g., see FIG. 3 for a card 19 for a person with a height of between 4 foot-7 inches and 5 feet, or FIG. 4 for a card 20 for a person with a height of between 5 foot-1 inch and 5 foot-6 inches). Other prompts and other indicia may be provided on the card to make the pillow selection device more intuitive and user-friendly to a purchaser. While this embodiment of the pillow selection device 16 has been described in connection with a booklet having a plurality of pillow selection cards, it can be appreciated that the pillow selection device 16 can be implemented on one card, and the card or cards could be replaced with any type of printed material and may even be affixed to or printed on the packaging of the pillow itself.

In the example shown in FIG. 2, three pillow selection criteria are identified along the vertical axis of the grid (e.g., gender, sleep position and allergies) and two pillow selection criteria are arranged along the horizontal axis (e.g., type of mattress, propensity to snore). By identifying one's particular set of pillow selection criteria, a recommended pillow can be determined. For example, pillow model “AF3MBN” would be identified as the recommended pillow model for a male purchaser having a height of 4 foot-three inches, who has a firm mattress, who predominately sleeps on his back, who rarely snores, and who does not have allergies. In a preferred embodiment, the pillow recommendations determined by the pillow selection system are in the form of pillow models which each contain a code that corresponds to the pillow selection criteria for that pillow. In the examples shown in FIGS. 2-4, the pillow models each have a six digit code. The chart below provides a legend for the code corresponding to the pillow models shown in FIGS. 2-4. However, it can be appreciated that any form or type of code may be used, such as the name of the pillow manufacturer and/or its brand name.

| Digit | Characteristic |
|---|---|
| 1 | Purchaser's Height |
| 2 | Mattress Firmness |
| 3 | Purchaser's Sex |
| 4 | Whether purchaser snores and how often |
| 5 | Purchaser's Sleep Position |
| 6 | Whether purchaser has allergies |

As shown in FIG. 1, once the purchaser determines the proper pillow model, the purchaser may obtain the pillow from the pillow display 11. As shown in FIG. 1, the pillow model 14 is displayed just below the associated bin containing pillows corresponding to the pillow model. The pillow model may also be displayed directly on the packaging for the pillow. This is especially helpful when customers do not put pillows back into their proper bin. The packaging for the pillow may also include indicia which includes or repeats the pillow selection criteria corresponding to the pillow model at issue so that the purchaser can confirm that they have in fact selected the correct pillow. Alternatively, the pillow selection device 16 itself may be affixed or printed directly on the pillow packaging thereby dispensing with the need for a separate pillow selection device 16 as shown in FIG. 1.

Ideally, the retail establishment would stock all of the pillow models identified by the pillow selection device 16. Alternatively, if the pillow model does not correspond to a pillow model provided by the retail establishment, one or more other pillow models having similar characteristics for the particular pillow selection criteria may be cross-referenced as a substitute model. Such a configuration also allows the retail establishment to stock fewer pillows. With such a configuration, the pillow selection device 16 may be customized for the specific needs of a particular retailer, for instance, a retailer with house brands or private labels or a retailer with limited inventory.

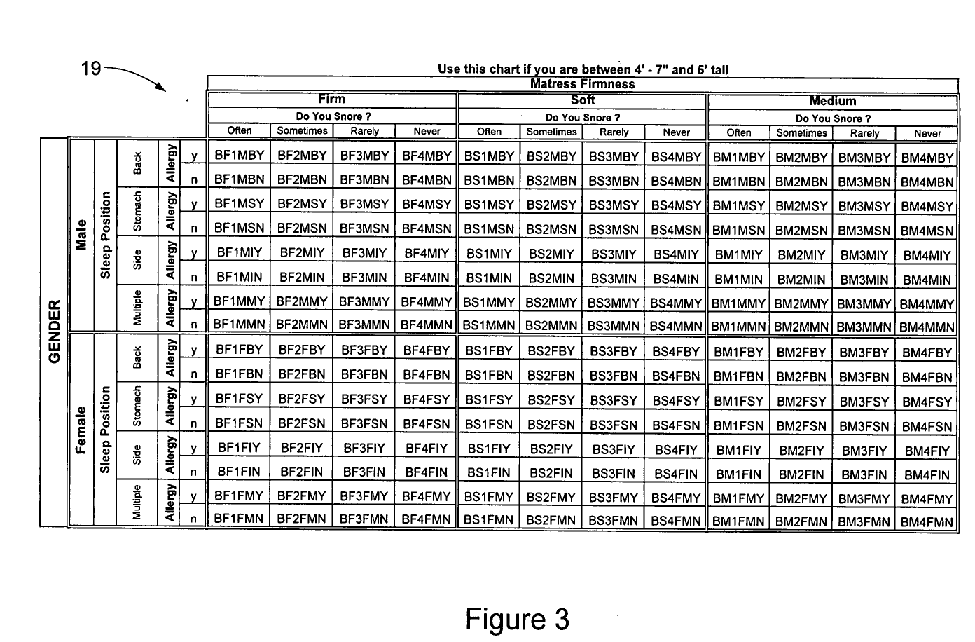

FIG. 5 shows a pillow selection device 16′ in accordance with another embodiment of the present invention. The pillow selection device 16′ of FIG. 5 comprises a computer and a database (not shown) having data related to the pillow selection criteria and pillow models. The computer may by in the form of a personal computer, kiosk, or any other device having a display 32, a processor 31 and means for a user to input information. The input means may be a keyboard, a “touch screen”, a mouse, or any other device that allows the purchaser to input information. Pillow selection software installed on or accessible via computer 30 is configured to retrieve the recommended pillow model for a user based upon the user's inputted pillow selection criteria. In the embodiment shown in FIGS. 5-9, processor 31 is connected to a central server 33 via a local area network to which other computers, such as order processing computers, in the store may also be connected. However, the pillow selection device may alternatively and/or also comprise one or more standalone PCs on which the pillow selection software is installed locally. The pillow selection software can also be made available through the Internet such that any device having Internet access (e.g., computer, phone, PDAs, etc.) and means for inputting information may be used. A printer (not shown) may also be provided to allow the purchaser to print the recommended pillow model, the pillow selection criteria associated therewith, and/or other related pillow information.

With further reference to FIGS. 5-9, the pillow selection software is accessed via display 32. In one embodiment, the plurality of pillow selection criteria are displayed in the form of questions to a prospective pillow purchaser. The pillow selection software defines a set of available answers corresponding to each question. For instance, in the case of the following pillow selection criteria, the questions and answers may be as follows:

| Screen | | |
|---|---|---|
| No. | Question | Answer Set |
| 1 | Gender | Male, Female |
| 2 | What is your height? | (4′ 0″ to 4′ 6″), (4′ 7″ to 5′), |
| | | (5′ 1″ to 5′ 6″), (5′ 7″ to 6′), |
| | | (6′ 1′ to 6′ 6″) |
| 3 | In what position do you | Side, Back, Stomach, Multiple |
| | generally sleep? | |
| 4 | In what position do you | Side, Back, Stomach, Multiple |
| | generally fall asleep? | |
| 5 | What firmness level | Plush, Medium, Firm |
| | is your mattress? | |
| 6 | Do you snore? | Never, Rarely, Sometimes, Often |
| 7 | Do you have allergies? | Yes, No |
| 8 | Do you have shoulder pain? | Yes, No |
| 9 | Do you have neck pain? | Yes, No |

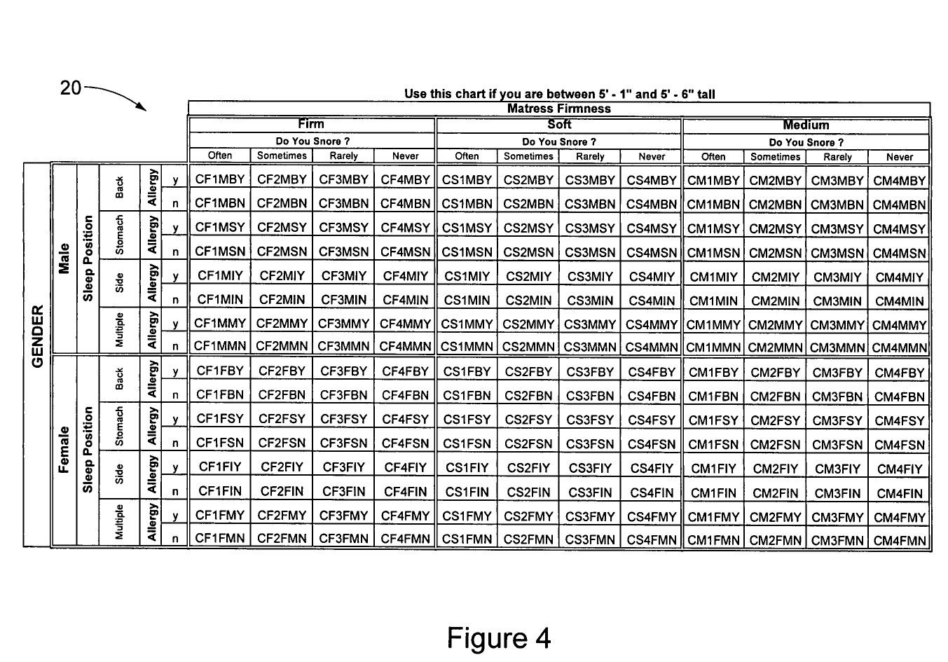

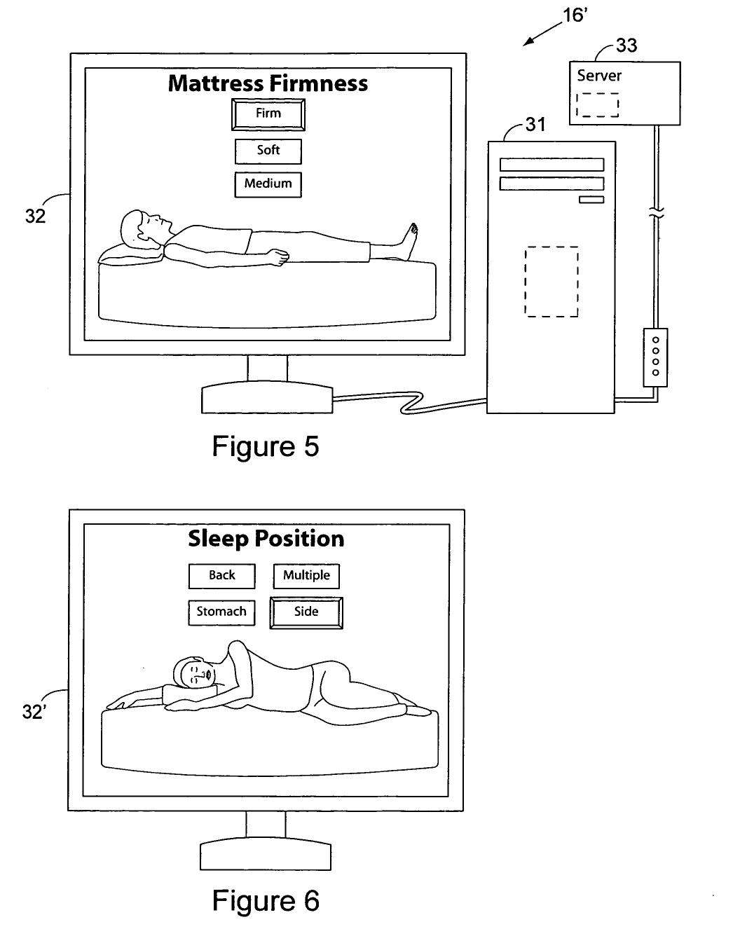

For example, in FIG. 5, the prospective pillow purchaser is prompted to select his or her type of mattress. In FIG. 6, the prospective pillow purchaser is prompted to indicate his or her sleeping position. Based on the prospective pillow purchaser's responses to these questions, the pillow selection software determines the recommended pillow, and displays it to the prospective pillow purchaser as shown in FIG. 7. In a preferred embodiment (not shown), pillow selection device 16′ also recommends at least one mattress pad and/or topper based on the purchaser's inputted pillow selection criteria.

In a preferred embodiment, the pillow selection system also prints a document having the recommended pillow model identified on it, thereby allowing the purchaser, as described previously, to either go to a bin displaying the pillow model to obtain the recommended pillow, or give to a salesperson to complete the purchase. The computer may also preferably store a purchaser's pillow selection criteria as a “personal profile”, thereby allowing the purchaser to retrieve, modify, or update their “personal profile,” as necessary.

The graphical displays generated by the pillow selection software are preferably chosen to increase the user friendliness of the pillow selection process and the pleasure of the shopping experience, and/or enhance the promotion and advertising of the pillows, related products and/or the establishment. For instance, when the purchaser inputs his or her gender, a graphic resembling a male or female form appears on the screen, as applicable. In an alternate embodiment, the graphics are self-intuitive so that once they appear, the purchaser is prompted to respond without the need for a word prompt. For example, in the case of FIG. 6, figures showing individuals in the various sleep positions could be used. In the case of the height pillow selection criteria, a graphic resembling the male or female form may increase or decrease in scale according to the purchaser's selection. When the purchaser has selected his or her predominant sleeping position, a graphic resembling the male or female form may become animated and move to the selected sleeping position. Likewise, when the firmness level of the mattress is input, a graphic of a male or female form shown lying on the mattress and the relationship of the mattress to the body position may be shown. For example, a side sleeper on a plush mattress is shown as having the shoulder dipping into the mattress as compared to a side sleeper on a firm mattress whose shoulder is shown without a mattress impression.

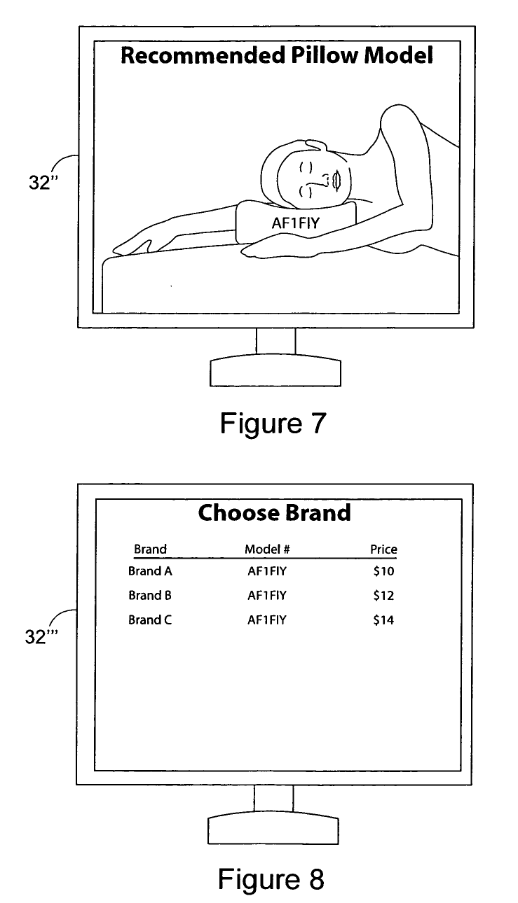

Once the prospective pillow purchaser has input all of the relevant pillow selection criteria, a graphic such as that shown in FIG. 7 representative of the purchaser and his or her particular pillow selection criteria may be displayed. In a preferred embodiment, the pillow selection software provides the prospective purchaser with at least one or more recommended substitute pillow models in the event his or her recommended pillow model is not available, and corresponding pricing information to assist the purchaser in his or her purchasing decision as shown in FIG. 8. In a preferred embodiment, the pillow selection software interfaces the establishment's order entry system allowing the purchaser to purchase a pillow directly from the pillow selection device.

As described previously, ideally a retailer will have an inventory of pillows corresponding to all possible pillow models. However, as a practical matter, retailers often only carry certain types of the most common pillow models or substitutes therefor. Accordingly, the pillow selection software preferably allows the retailer to customize the database. The database also preferably interacts with a retail establishment's inventory control system to provide the purchaser with options in selecting a pillow in the event the recommended pillow model is out of stock.

As various changes could be made in the above constructions and methods without departing from the scope of the invention, it is intended that all matter contained in the above description or shown in the accompanying drawings shall be interpreted as illustrative and not in any limiting sense. For example, while the pillow selection system has been described in connection with a purchaser, it may also be used by a salesperson to assist him or her with a customer. The invention therefore shall be limited solely by the scope of the claims set forth below, and their legal equivalents.

What is claimed is:

1. A system for assisting an individual in the selection of a pillow, the system comprising:
a pillow selection device adapted to display pillow selection criteria from which the individual can determine at least one recommended pillow model based on the individual's pillow selection criteria.

2. The system of claim 1, wherein the pillow selection criteria comprise at least one of a mattress type, sleeping position, gender, height, propensity to snore, the presence or absence of allergies, the presence or absence of shoulder pain, and the presence or absence of neck pain.

3. The system of claim 1, wherein the pillow selection device comprises at least one pillow selection card, the pillow selection card comprising a plurality of rows and columns defining a plurality of slots, each slot representing a set of pillow selection criteria and identifying at least one pillow model recommended for that set of pillow selection criteria.

4. The system of claim 3, wherein the pillow selection device comprises a plurality of pillow selection cards, each pillow selection card corresponding to a range of heights.

5. The system of claim 1, wherein the pillow selection device is further adapted to display at least one recommended mattress pad and topper for each recommended pillow model.

6. A computer-readable medium having computer-executable instructions for performing steps in a computer system for assisting an individual having certain pillow selection criteria in the selection of a pillow, the steps comprising:
providing a graphical user interface configured to request and receive input from the individual related to his or her pillow selection criteria; and
determining at least one recommended pillow for the individual based on the received pillow selection criteria.

7. The computer-readable medium of claim 6, wherein the step of determining comprises:
identifying a pillow model for each of the plurality of pillows; and
correlating each pillow model to a set of pillow selection criteria.

8. The computer-readable medium of claim 6, wherein the pillow selection criteria comprise at least one of a mattress type, sleeping position, gender, height, propensity to snore, the presence or absence of shoulder pain, and the presence or absence of neck pain.

9. The computer-readable medium of claim 6, further comprising storing the individual's pillow selection criteria.

10. The computer-readable medium of claim 6, wherein the graphical user interface is configured to display graphics indicative of the input received.

11. The system of claim 10, wherein the graphics comprise at least one of a sleeping position and the individual's gender.

12. The system of claim 6, further comprising determining at least one recommended mattress pad and topper for the recommended pillow.

13. A system for assisting an individual in the selection of a pillow from a plurality of pillows, comprising:
a graphical user interface configured to request and receive input from the individual related to his or her pillow selection criteria; and
means for determining at least one recommended pillow for the individual based on the received pillow selection criteria.

14. The system of claim 13, wherein the determining means comprises:
identifying a pillow model for each of the plurality of pillows; and
correlating each pillow model to a set of pillow selection criteria.

15. The system of claim 13, wherein the pillow selection criteria comprise at least one of a mattress type, sleeping position, gender, height, propensity to snore, the presence or absence of shoulder pain, and the presence or absence of neck pain.

16. The system of claim 13, wherein the graphical user interface comprises a touch screen.

17. The system of claim 13, wherein the graphical user interface comprises a display and at least one of a keyboard and a mouse.

18. The system of claim 13, further comprising means for storing the individual's pillow selection criteria.

19. The system of claim 13, wherein the graphical user interface is configured to display graphics indicative of the input received.

20. The system of claim 13, wherein the graphics comprise at least one of a sleeping position and the individual's gender.

21. The system of claim 14, wherein each of the plurality of pillows comprises packaging having its corresponding pillow model identified thereon.

22. The system of claim 14, further comprising determining at least one recommended mattress pad and topper for the recommended pillow.

23. A method of assisting an individual in the selection of a pillow from a plurality of pillows based on his or her pillow selection criteria, comprising:
presenting a plurality of screen displays to the individual requesting his or her pillow selection criteria;
receiving the individual's pillow selection criteria; and
determining at least one recommended pillow based on the received pillow selection criteria.

24. The method of claim 23, wherein the step of determining comprises:
identifying a pillow model for each of the plurality of pillows; and
correlating each pillow model to a set of pillow selection criteria.

25. The method of claim 23, further comprising storing the individual's pillow selection criteria.

26. The method of claim 23, further comprising determining at least one recommended mattress pad and topper for the recommended pillow.
